(19) United States
(12) Patent Application Publication
(10) Pub. No.: US 2015/0027576 A1
(43) Pub. Date: Jan. 29, 2015

(54) Automatic Material Adder

(71) Applicant: Solis Hight-tech Ind. (Shenzhen) Ltd., Shenzhen (CN)

(72) Inventors: Chunhou Li, Shenzhen (CN); Liang Jie, Shenzhen (CN); Hongbiao Dong, Shenzhen (CN); Zhijun Liu, Shenzhen (CN); Jianbin Xiao, Shenzhen (CN); Yafei Duan, Shenzhen (CN); Xiaoyong Jie, Shenzhen (CN); Jiasong Zhang, Shenzhen (CN)

(21) Appl. No.: 14/341,851

(22) Filed: Jul. 28, 2014

(30) Foreign Application Priority Data
Jul. 29, 2013 (CN) 201310323743.8

(51) Int. Cl. B01F 5/24; B01F 15/00

(52) U.S. Cl. CPC B01F 5/245; B01F 15/00123
USPC 137/897

(57) ABSTRACT

An automatic material adder includes a reaction container, a feed storage tank, installed at the top of the reaction container; and at least one liquid bottle, installed adjacent to the feed storage tank, and having a feeding end and a liquid transfer end of the liquid bottle directly or indirectly interconnected with the interior of the reaction container, and the feeding end of the feed storage tank further having an automatic switching device for feeding a material at a fixed time, and the reaction container having a water inlet formed on a sidewall of the reaction container, and a siphon draining device installed on the bottom wall of the reaction container for discharging a mixture contained in the reaction container to the outside.

### CROSS-REFERENCE TO RELATED APPLICATIONS

This non-provisional application claims priority under 35 U.S.C. §119(a) on Patent Application No(s). 201310323743.8 filed in China on Jul. 29, 2014, the entire contents of which are hereby incorporated by reference.

### BACKGROUND OF THE INVENTION

1. Field of the Invention

The present invention relates to an automatic material adder applied in the fields of biological farming, creature appreciation, and pet raising for feeding a material (or medicine) to control the reaction time and reduce the power consumption to a low or even zero level.

2. Description of the Related Art

In biological farming including aquaculture, creature appreciation and pet raising, feeding is a necessary process. It is common to feed living creatures by adding biological agents or medicines into a feed before feeding the living creatures.

At present, various different adders available in the market are mainly divided into two types, respectively: a manual adder and an automatic material adder which is controlled by an electric power source, and the feeding process of the former totally relies on manpower, and thus not just requiring more labor efforts and a complicated material adding process, but also failing to mix and react the feed and the medicine sufficiently, and causing a waste since the material often remains on the adder. Although the latter can achieve the effects of adding materials automatically and controlling the quantity of fed material effectively, but it consumes electric power. In addition, most of the present adders can add one material only. Therefore, it is a main subject for related manufacturers to upgrade the product technology by designing and developing an adder capable of dissolving, reacting and mixing liquids (or additives) sufficiently while adding several liquids (or additives) automatically at the same time, and achieving the effect of minimizing the power consumption or even reducing the power consumption down to a zero level.

### SUMMARY OF THE INVENTION

In view of the problems of the prior art, it is a primary objective of the present invention to provide an automatic material adder capable of adding several materials (or medicines), controlling the reaction time, and reducing the power consumption (even down to a zero level).

To achieve the aforementioned objective, the present invention provides an automatic material adder, comprising: a reaction container; a feed storage tank, installed at the top of the reaction container; and at least one liquid bottle, installed adjacent to the feed storage tank, and having a feeding end and a liquid transfer end of the liquid bottle directly or indirectly interconnected with the interior of the reaction container, and the feeding end of the feed storage tank further having an automatic switching device for feeding a material at a fixed time, and the reaction container having a water inlet formed on a sidewall of the reaction container, and a siphon draining device installed on the bottom wall of the reaction container for discharging a mixture contained in the reaction container to the outside.

Wherein, the automatic material adder further comprises a mixer that separates the reaction container into an upper-layer reaction area and a lower-layer reaction area, and the upper-layer reaction area and lower-layer reaction area are interconnected indirectly or directly, and the siphon draining device is installed in the lower-layer reaction area, and the quantity of the liquid bottles is equal to two or more, and the liquid bottles is disposed precisely above the reaction container, and the liquid transfer end of each liquid medicine bottle has a valve switching device, and the liquid transfer ends of the two or more liquid bottles is extended into the mixer, so that a liquid (or additive) is pre-mixed in the mixer.

Wherein, the mixer is a conical funnel, and the conical funnel has a threaded hole formed at an opening at the middle of the conical funnel, and a screw is installed at a gap in the operation, and a spiral reaction space is defined at a thread space between the screw and the opening.

Wherein, the mixer is in an inverted conical shape and has a mixed liquid siphon pipe disposed at the bottom of the mixer, and the mixed liquid siphon pipe is interconnected to the upper-layer reaction area and the lower-layer reaction area.

Wherein, the siphon draining device is comprised of at least one siphon pipe, and an end of the siphon pipe abuts the bottom wall of the reaction container, and the other end of the siphon pipe is extended towards a mid-high position of the reaction container, and then bent for at least one time, and finally passed through the bottom wall of the reaction container and extended out of the reaction container.

Wherein, the siphon pipe has an end passed out from the bottom wall of the reaction container and perpendicular to the bottom wall.

Wherein, the water inlet is disposed at a mid-high position of the sidewall of the reaction container, and the position of the water inlet is higher than the highest bending point of the siphon pipe, and the water inlet has a water inlet pipe and an inputted water regulating valve installed thereon.

In summation, the present invention has the following advantages and effects: in the present invention, the feeding end of the feed storage tank has an automatic switching device for feeding materials at a fixed time, and the liquid (or additive) contained in the liquid bottle flows into the reaction container due to its gravitational force. After a default time, the automatic switching device is operated, and the feed contained in the feed storage tank is fed into the reaction container and mixed with the liquid (or additive) contained in the reaction container, and then flows into water, so that the feed and the liquid (or additive) are mixed sufficiently. If the lower level of the reaction container exceeds the siphon level of the siphon draining device, the mixed liquid contained in the reaction container is discharged to the reaction container through the siphon effect. In a material adding process for the biological farming, the present invention controls the quantity of the feed the feeding time. In the process of feeding one or more feeds and additives, the feeds and additives are absorbed, reacted, diluted and mixed sufficiently without requiring any power consumption, since the liquid pressure is used as power to complete the material adding process automatically.

### BRIEF DESCRIPTION OF THE DRAWINGS

FIG. 1 is a schematic view of an automatic material adder in accordance with a. first preferred embodiment of the present invention;

FIG. 2 is a schematic view of an automatic material adder in accordance with a second preferred embodiment of the present invention;

FIG. 3 is a schematic view of an automatic material adder in accordance with a. third preferred embodiment of the present invention; and

FIG. 4 is a schematic view of an automatic material adder in accordance with a. fourth preferred embodiment of the present invention.

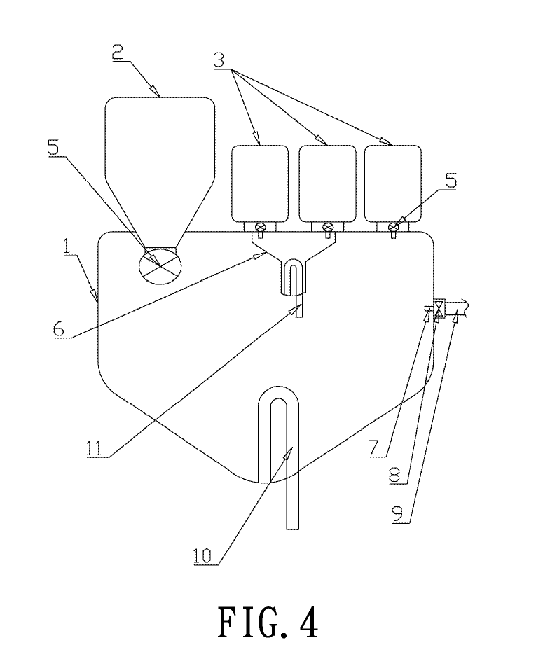

### DETAILED DESCRIPTION OF THE PREFERRED EMBODIMENTS

The aforementioned and other objectives, technical characteristics and advantages of the present invention will become apparent with the detailed description of preferred embodiments and the illustration of related drawings as follows.

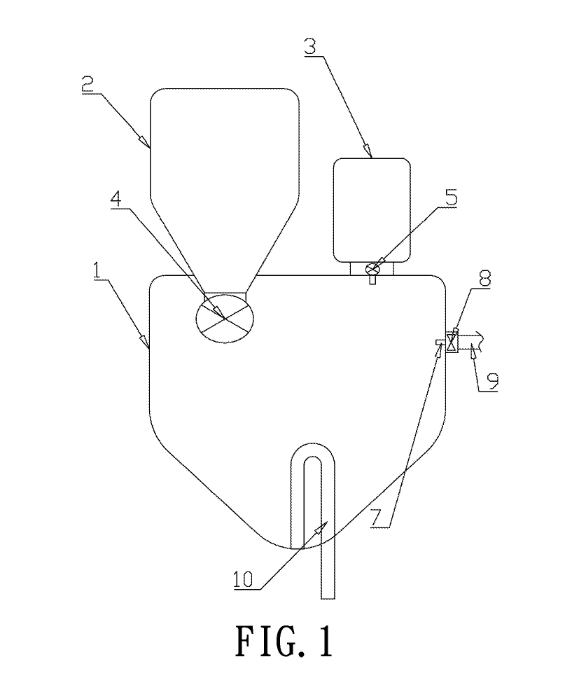

With reference to FIG. 1 for an automatic material adder in accordance with the first preferred embodiment of the present invention, the automatic material adder comprises a reaction container 1, a feed storage tank 2 installed at the top of the reaction container 1, and at least one liquid bottle 3 installed adjacent to the feed storage tank, and a feeding end of the feed storage tank 2 and a liquid transfer end of the liquid bottle 3 is directly or indirectly interconnected with the reaction container 1, and the feeding end of the feed storage tank 2 further has an automatic switching device 4 for adding materials at a fixed time, and a water inlet 7 is formed on a sidewall of the reaction container 1, and a siphon draining device is installed on the bottom wall of the reaction container 1 for discharging the mixture contained in the reaction container 1 to the outside.

Since the automatic switching device 4 is installed at the feeding end of the feed storage tank 2 for adding materials at a fixed time, the liquid (or additive) contained in the liquid bottle 3 flows into the reaction container 1 due to the gravitational force. After the default time, the automatic switching device 4 is operated, and the feed contained in the feed storage tank 2 is added into the reaction container and mixed with the liquid (or additive) contained in the reaction container, and flows into water through the water inlet, so that the feed and the liquid (or additive) are mixed sufficiently. if the water level of the reaction container exceeds the siphon level of the siphon draining device, the mixed liquid contained in the reaction container is discharged to the outside through the siphon effect. In the process of adding materials for biological farming, the quantity of the feed and the time of adding the feed are controlled, so that one or more feeds and additives can be absorbed, reacted, diluted, and mixed sufficiently, and the effect of minimizing the power consumption or even reducing the power consumption down to a zero level can be achieved

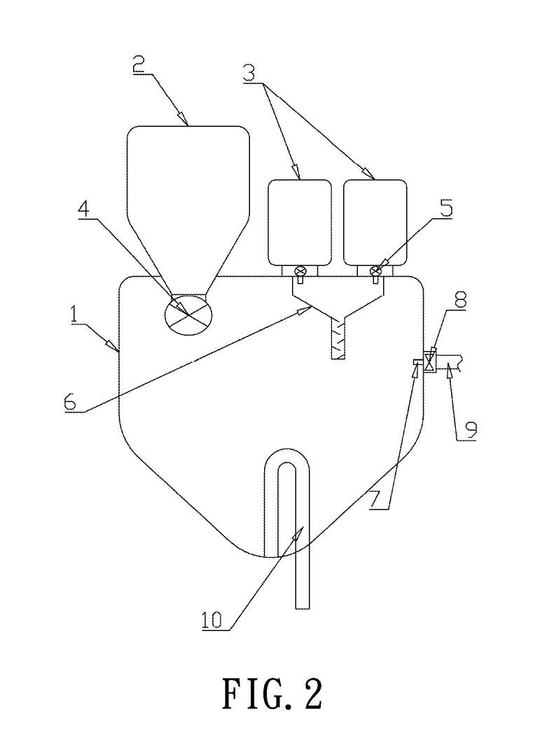

With reference to FIG. 2 for an automatic material adder of the second preferred embodiment of the present invention, the automatic material adder further comprises a mixer 6 that divides the reaction container 1 into an upper-layer reaction area and a lower-layer reaction area, and the upper-layer reaction area and the lower-layer reaction area are interconnected indirectly or directly, and the siphon draining device is installed in the lower-layer reaction area, and the quantity of liquid bottles 3 is equal to two, and the liquid bottles 3 are disposed precisely above the reaction container 1, and a liquid transfer end of each liquid bottle 3 has a valve switching device 5 for regulating the quantity of liquid transfer 5, and the valve switching device 5 is provided for reacting or mixing the materials contained in the liquid bottle according to a specific proportion. The liquid transfer ends of the two liquid bottle 3 are extended into the mixer, so that the liquid (or additive) is pre-mixed by the mixer 6, wherein the mixer 6 is a conical funnel, and a threaded hole is formed at an opening at the middle of the conical funnel, and a screw is installed in a gap inside the opening, and a spiral mixed liquid space is formed at a threaded gap between the screw and the opening, and the liquid (or additive) of the liquid bottle 3 flows into the mixer due to its gravitational force, and passed through the mixed liquid space between the screw and the opening and mixed sufficiently, and finally entered into the lower-layer reaction area. By regulating the water inflow by the inputted water regulating valve 8, the mixture flows through the water inlet into water, and the mixture is diluted. A specific quantity of the mixture flows into the reaction container 1 for the dissolving, reacting, and mixing processes. If the liquid level of the mixture exceeds the siphon level of the siphon draining device after a specific time, the mixed liquid contained in the lower-layer reaction area is discharged out of the reaction container 1 by the siphon effect. The material adding process can be completed automatically and accurately without requiring the attendance of any operator.

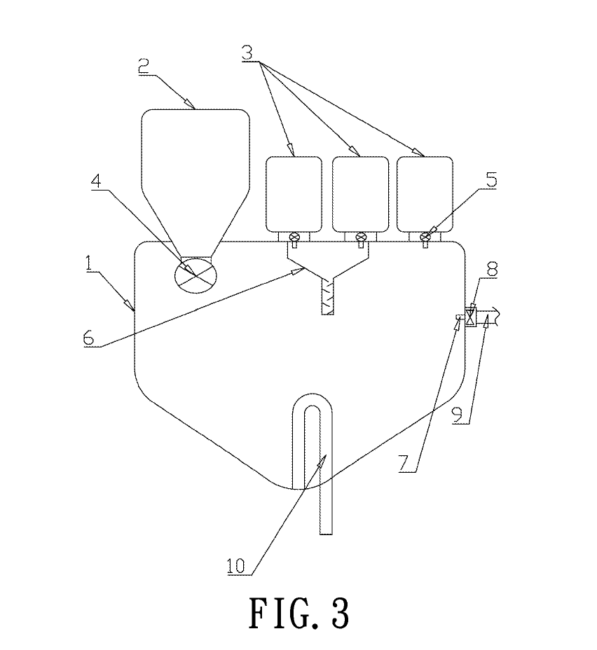

With reference to FIG. 3 for an automatic material adder of the third preferred embodiment of the present invention, the difference between the third preferred embodiment and the second preferred embodiment resides on the different quantities of the liquid bottles 3.

With reference to FIG. 3 for an automatic material adder of the fourth preferred embodiment of the present invention, the mixer 6 is in an inverted conical shape, and the bottom of the mixer 6 includes a mixed liquid siphon pipe 11 interconnected to the upper-layer reaction area and the lower-layer reaction area. After the liquid (or additive) is mixed in the mixer 6, the mixed liquid is discharged into the lower-layer reaction area through the mixed liquid siphon pipe 11.

Wherein, the siphon draining device is comprised of at least one siphon pipe 10, and an end of the siphon pipe 10 abuts the bottom wall of the reaction container 1, and the other end of the siphon pipe 10 is extended to a mid-high position of the reaction container 1 and then bent for at least one time, and finally passed through the bottom wall of the reaction container 1 and extended out from the reaction container to the outside. With the siphon pipe 10, the liquid (or additive) can be reacted sufficiently.

Wherein, the end of the siphon pipe 10 passing out from the bottom wall of the reaction container is perpendicular to the bottom wall, so that the liquid (or additive) outputted from the siphon pipe 10 is entered into a liquid addition position perpendicularly.

In a preferred embodiment, the water inlet 7 is disposed at a mid-high position of a sidewall of the reaction container, and the position of the water inlet 7 is higher than the highest bending point of the siphon pipe 10, and the water inlet 7 has a water inlet pipe 9 and an inputted water regulating valve 8 installed thereon, and the inputted water regulating valve 8 is provided or adjusting the quantity and inflow of water.

What is claimed is:

1. An automatic material adder, comprising:
a reaction container;
a feed storage tank, installed at the top of the reaction container; and
at least one liquid bottle, installed adjacent to the feed storage tank, and having a feeding end and a liquid transfer end of the liquid bottle directly or indirectly interconnected with the interior of the reaction container, and the feeding end of the feed storage tank further having an automatic switching device for feeding a material at a fixed time, and the reaction container having a water inlet formed on a sidewall of the reaction container, and a siphon draining device installed on the bottom wall of the reaction container for discharging a mixture contained in the reaction container to the outside.

2. The automatic material adder of claim 1, further comprising a mixer that separates the reaction container into an upper-layer reaction area and a lower-layer reaction area, and the upper-layer reaction area and lower-layer reaction area being interconnected indirectly or directly, and the siphon draining device being installed in the lower-layer reaction area, and the quantity of the liquid bottles being two or more, and the liquid bottles being disposed precisely above the reaction container, and the liquid transfer end of each liquid medicine bottle having a valve switching device, and the liquid transfer ends of the two or more liquid bottles being extended into the mixer, so that a liquid (or additive) being pre-mixed in the mixer.

3. The automatic material adder of claim 2, wherein the mixer is a conical funnel, and the conical funnel has a threaded hole formed at an opening at the middle of the conical funnel, and a screw is installed at a gap in the operation, and a spiral reaction space is defined at a thread space between the screw and the opening.

4. The automatic material adder of claim 2, wherein the mixer is in an inverted conical shape and has a mixed liquid siphon pipe disposed at the bottom of the mixer, and the mixed liquid siphon pipe is interconnected to the upper-layer reaction area and the lower-layer reaction area.

5. The automatic material adder of claim 3, wherein the siphon draining device is comprised of at least one siphon pipe, and an end of the siphon pipe abuts the bottom wall of the reaction container, and the other end of the siphon pipe is extended towards a mid-high position of the reaction container, and then bent for at least one time, and finally passed through the bottom wall of the reaction container and extended out of the reaction container.

6. The automatic material adder of claim 5, wherein the siphon pipe has an end passed out from the bottom wall of the reaction container and perpendicular to the bottom wall.

7. The automatic material adder of claim 5, wherein the water inlet is disposed at a mid-high position of the sidewall of the reaction container, and the position of the water inlet is higher than the highest bending point of the siphon pipe, and the water inlet has a water inlet pipe and an inputted water regulating valve installed thereon.

8. The automatic material adder of claim 4, wherein the siphon draining device is comprised of at least one siphon pipe, and an end of the siphon pipe abuts the bottom wall of the reaction container, and the other end of the siphon pipe is extended towards a mid-high position of the reaction container, and then bent for at least one time, and finally passed through the bottom wall of the reaction container and extended out of the reaction container.

9. The automatic material adder of claim 8, wherein the siphon pipe has an end passed out from the bottom wall of the reaction container and perpendicular to the bottom wall.

10. The automatic material adder of claim 8, wherein the water inlet is disposed at a mid-high position of the sidewall of the reaction container, and the position of the water inlet is higher than the highest bending point of the siphon pipe, and the water inlet has a water inlet pipe and an inputted water regulating valve installed thereon.
